(19) United States
(12) Patent Application Publication
(10) Pub. No.: US 2023/0324620 A1
(43) Pub. Date: Oct. 12, 2023

(54) HIGH EFFICIENCY GRATING COUPLER DESIGNS AND APPLICATIONS

(71) Applicant: The Board of Trustees of the University of Illinois, Urbana, IL (US)

(72) Inventors: Lynford L. Goddard, Champaign, IL (US); Shaneen F. Braswell, Marlton, NJ (US)

(21) Appl. No.: 17/718,931

(22) Filed: Apr. 12, 2022

(51) Int. Cl. G02B 6/34; G02B 27/00

(52) U.S. Cl. CPC G02B 6/34; G02B 27/0012

(57) ABSTRACT

A high efficiency grating coupler design includes a grating region formed of a first material on an optics substrate. A side reflector formed of the first material is disposed on the optics substrate adjacent the grating region. A high contrast overlay is on the grating region, but is not disposed on the side reflector. The grating region includes teeth formed of the first material and the high contrast overlay, wherein the teeth have independently apodized fill factor, etch depth, and heights The first material and a material of the high contrast overlay can be selected to correspond to a particular laser type, wavelength of the laser, properties of the laser beam, and material of the laser. In addition, the teeth of the grating region, along with the side reflector teeth, can be apodized for optimized optical coupling efficiency with respect to the laser.

### GOVERNMENT SUPPORT

This invention was made with Government support under Grant No. 1640196 awarded by the National Science Foundation. The United States Government has certain rights to this invention.

### BACKGROUND

The advent of modern communication has driven industrial demands to increase data rates and bandwidth for communications and computing applications. Energy-efficient, optical interconnects for multi-chip high-performance computing applications necessitate ultra-fast, scalable, and low-loss capabilities to outperform conventional electrical interconnects that are limited in speed, scalability, and bandwidth. Integrated photonics are becoming increasingly popular for the long distance interconnects of telecommunication systems as well as for shorter interconnect distances for on-chip and chip-to-chip communication and other optics and light-based applications.

For wide adoption, it is important for the optical components to minimize loss of coupling efficiency between integrated circuit materials, waveguides, and optical fibers. Grating couplers are an attractive solution for providing fiber to waveguide coupling. Grating couplers are designed as a region on top of or below a waveguide to assist with coupling light into or out of the waveguide via a grating. A grating is a periodically spaced collection of material or geometrical variations. Advantageously, grating couplers can be easily fabricated on an integrated circuit chip; however, conventional grating couplers suffer from relatively low coupling efficiency (e.g., less than about 60%) and narrow bandwidth (e.g., between 30-40 nm).

Accordingly, there is a need for high efficiency grating couplers for optical interconnect and light-based applications.

### BRIEF SUMMARY

High efficiency grating coupler designs and applications are provided. A high efficiency grating coupler is provided having a periodically spaced collection of geometrical variation, formed through the use of elongated elements, or teeth that are independently apodized for optimized coupling efficiency. Parameters of this grating coupler may be designed for a particular laser using a design automation tool with features supporting high efficiency grating coupler design as described herein.

A design automation tool executed at a computing device can perform a method including receiving parameters for a laser for which a grating coupler is being designed, wherein the parameters for the laser comprise a laser type, wavelength of the laser, material of the laser, and properties of the laser beam of the laser such as diameter, propagation direction, and polarization; determining a corresponding initial grating coupler specification for the laser based on the received parameters. Here, the initial grating coupler specification can be selected from a set of initial grating coupler specifications, wherein the set of initial grating coupler specifications comprise at least one high contrast overlay initial grating coupler specification. In some cases, the set of initial grating coupler specifications further include at least one all-polymer initial grating coupler specification. Once the parameters for the laser are received and the corresponding initial grating coupler specification is determined by the computing device based on the received parameters, the method includes performing a set of simulations while varying design parameters of the initial grating coupler specification to identify optimal uniform design parameters of the grating coupler for the laser; optionally performing a constrained optimization such that the resulting dimensions are fabricable by a selected set of tools; optionally applying an initial side reflector specification to the grating coupler having the identified optimal design parameters; performing apodization, including associated simulations, of fill factor, etch depth, and heights for each grating tooth starting from one side until all grating teeth are independently apodized and an optical coupling efficiency is determined by the associated simulations; and providing specifications of the grating coupler having the apodized fill factor, etch depth, and heights. These resulting specifications can be used to fabricate the grating coupler.

The simulations performed by the design automation tool can be any suitable grating coupler simulation process either built-in to the design automation tool or accessible by the design automation tool and provided by another application that can receive the varying design parameters of the initial grating coupler specification and/or the apodized fill factor, etch depth, and height values (or step size) generated by the design automation tool.

A high efficiency grating coupler, which may be designed using the above described design automation tool, can include a grating region formed of a first material on an optics substrate; a side reflector formed of the first material, the side reflector being on the optics substrate adjacent the grating region, wherein the side reflector comprises side reflector teeth having apodized fill factor, etch depth, and heights; and a high contrast overlay on the grating region, wherein the high contrast overlay is not disposed on the side reflector, wherein the grating region comprises teeth formed of the first material and the high contrast overlay, wherein the teeth have independently apodized fill factor, etch depth, and heights.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A-1C illustrates a grating coupler design of a representative grating coupler.

FIG. 1D shows a perspective view of a rectangular grating design.

FIG. 1E illustrates certain design parameters of a grating coupler.

FIG. 1F illustrates a grating coupler design that includes a high contrast overlay as described herein.

FIG. 2 illustrates a method carried out by a design automation tool for generating a high efficiency grating coupler design.

FIGS. 3A and 3B illustrate example high efficiency grating coupler designs that can be generated by a design automation tool described herein.

FIG. 4 is a block diagram illustrating components of a computing device used for automated grating coupler design

FIG. 5 illustrates an example block diagram of an electronic-photonic integrated circuit.

FIG. 6A shows a representative schematic of an optimized grating coupler designed for a particular vertical cavity transistor laser.

FIG. 6B is a plot of fill factor of the apodized optimized grating coupler of FIG. 6A.

FIG. 6C is an electric field simulation plot illustrating the electric field profile in the optimal design of the apodized optimized grating coupler of FIG. 6A.

FIGS. 7A and 7B show a top view and cross section view of a representative apodized polymer grating structure.

FIG. 7C is an electric field simulation plot illustrating optimal design of the apodized polymer grating coupler of FIG. 7B.

### DETAILED DESCRIPTION

High efficiency grating coupler designs and applications are provided. A high efficiency grating coupler is provided having a periodically spaced collection of geometrical variation, formed through the use of elongated elements, or teeth that are independently apodized for optimized coupling efficiency. Parameters of this grating coupler may be designed for a particular laser using a design automation tool with features supporting high efficiency grating coupler design as described herein

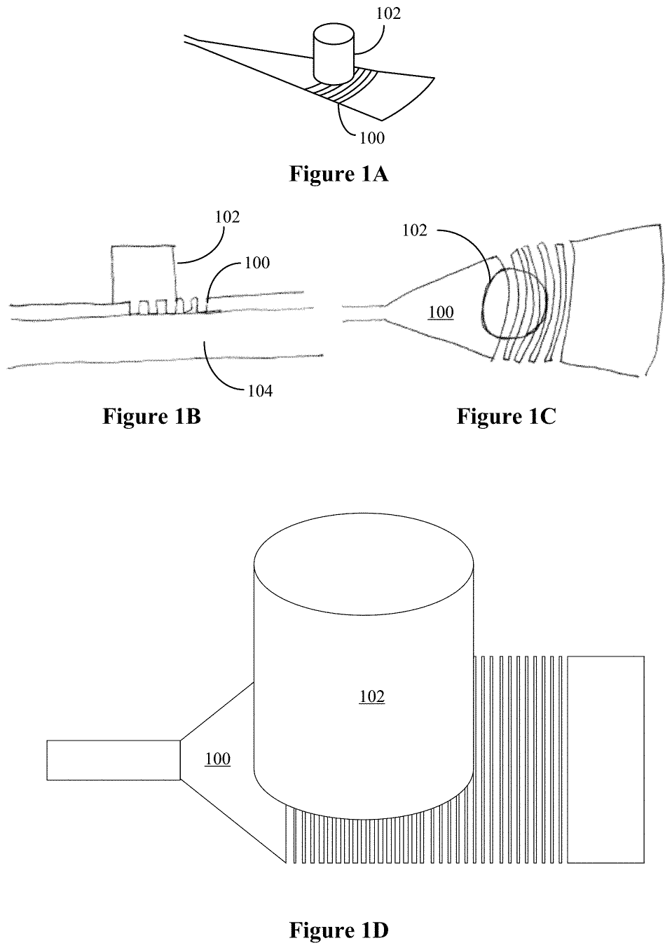

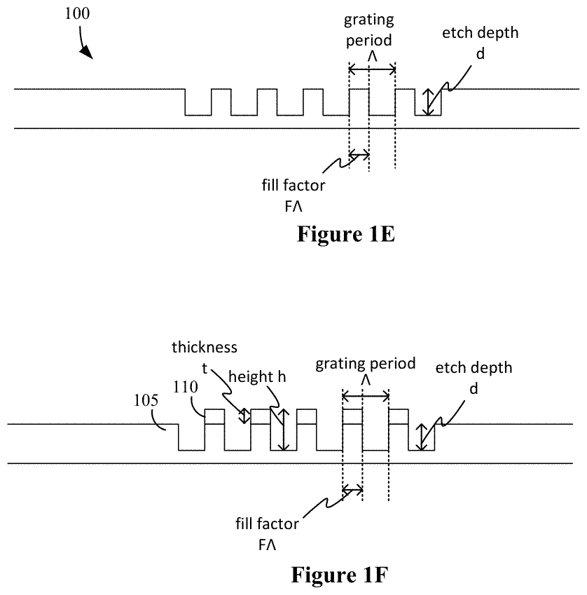

FIGS. 1A-1C illustrates grating coupler design of a representative grating coupler; FIG. 1A shows a perspective view of a focused grating design; FIG. 1B shows a side view cross-section of a focused grating design; and FIG. 1C shows a top view of a focused grating design. FIG. 1D shows a perspective view of a rectangular grating design. FIG. 1E illustrates certain design parameters of a grating coupler. Figure IF illustrates a grating coupler design that includes a high contrast overlay as described herein.

Referring to FIGS. 1A-1E, when designing a grating coupler 100 that couples an optical fiber 102 to a waveguide 104, there are a number of design parameters for consideration to provide appropriate refractive index variation and conversion of a coupled fiber mode to a waveguide mode. In particular, as shown in FIG. 1E, available design parameters include grating period A, etch depth d (which relates to the height of a tooth), and fill factor FA. The fill factor FA refers to the fraction of the grating period that is filled with grating material.

Referring to Figure IF, a high efficiency grating coupler can include a grating region formed of a first material 105 on an optics substrate (e.g., which may include waveguide 104) and a side reflector (not shown) formed of the first material 105 and that is on the optics substrate adjacent the grating region. As can be seen in FIG. 1F, the grating coupler includes a high contrast overlay 110 on the grating region, but which is not disposed on the side reflector. The grating region has teeth formed of the first material 105 and the high contrast overlay 110

As shown in FIG. 1F, an additional design parameter is shown for a grating coupler with high contrast overlay 110, which is thickness t of the overlay 110. It can be seen that with the overlay 110, the height h of an individual grating tooth includes both the height of the original grating material (which is the etch depth d effected by any reduction in height of the tooth part due to etch or polishing) and the thickness t of the overlay material, resulting in another parameter that can be optimized—the ratio. As described herein, the teeth of the grating region (as well as the side reflector teeth) can have independently apodized fill factor, etch depth, and heights.

While most optimizations for coupling efficiencies involve adjustments to grating period and fill factor, the described automated design tools can adjust both fill factor, etch depth, and heights of individual grating teeth (which may be the same as etch depth for cases having no overlay material). In addition, for the described automation tools, selective application of high contrast overlays is also possible, along with optimization of the thickness of the high contrast overlay (e.g., contribution to total height or ratio or as an independent variable).

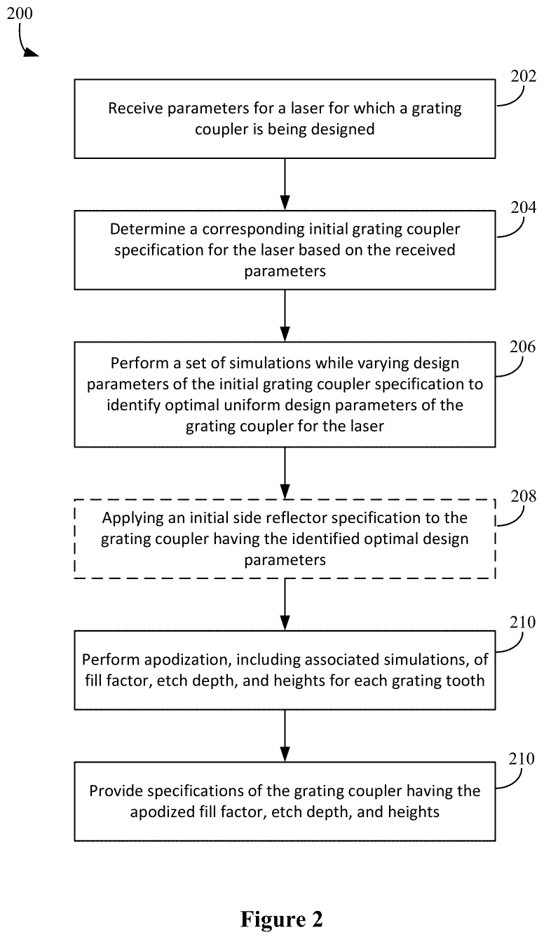

FIG. 2 illustrates a method carried out by a design automation tool for generating a high efficiency grating coupler design. Referring to FIG. 2, a method 200 for automated grating coupler design includes receiving (202) parameters for a laser for which a grating coupler is being designed, wherein the parameters for the laser can include one or more parameters such as, but not limited to, a laser type, wavelength of the laser, material of the laser, and properties of the laser beam of the laser such as diameter, propagation direction, and polarization; determining (204) a corresponding initial grating coupler specification for the laser based on the received parameters; performing (206) a set of simulations while varying design parameters of the initial grating coupler specification to identify optimal uniform design parameters of the grating coupler for the laser; optionally applying (208) an initial side reflector specification to the grating coupler having the identified optimal design parameters; performing (210) apodization, including associated simulations, of fill factor, etch depth, and heights for each grating tooth starting from one side until all grating teeth are independently apodized and an optical coupling efficiency is determined by the associated simulations; and providing (212) specifications of the grating coupler having the apodized fill factor, etch depth, and heights. In some cases, method 200 can include optionally performing a constrained optimization such that the resulting dimensions are fabricable by a selected set of tools;

Different lasers require different materials for the grating coupler as well as different grating periods (e.g., for the particular laser material, wavelength, and beam properties). A library of a set of initial grating coupler specifications can be stored with mappings to laser type, wavelength of the laser, material of the laser, and beam properties of the laser. The library provides standard and custom photonic components that can be easily input to a process design toolkit (PDK) for design of photonic integrated circuits. The corresponding initial grating coupler specification for a particular laser can be selected from the set of initial grating coupler specifications. The set of initial grating coupler specifications include at least one high contrast overlay initial grating coupler specification. For example, an example high contrast overlay initial grating coupler specification can be a silicon nitride (Si₃N₄) grating coupler with an amorphous silicon overlay selected as a result of receiving laser parameters indicating a 980 nm laser buried in silicon oxide. An initial grating period and initial fill factor are included as part of the initial grating coupler specification. In some cases, the initial grating coupler specification can include bottom cladding and substrate information. In some cases, the set of initial grating coupler specifications further includes at least one all-polymer initial grating coupler specification.

Any suitable data structure may be used to store the various mappings. For example, a look-up table may be used. Accordingly, when the method 200 receives (202) the parameters for the laser for which a grating coupler is being designed, the design automation tool can determine (204) the corresponding initial grating coupler specification by using the library mappings. In some cases, one or more drop down menus may be provided in order to facilitate the receipt of the laser parameters. In some cases, a natural language statement can be received via an input field (or even via audio input) and the text used to identify the laser parameters (e.g., via any suitable natural language processing, slot classifier, etc.). The user interface for the automated design tool can be any suitable custom process design toolkit interface to the automated design tool.

In some cases, the design automation tool can provide a user input to select whether to include a side reflector for the grating coupler. In some cases, the design automation tool automatically determines whether the side reflector should be included based on the laser parameters, other information related to the photonic integrated circuit application, and/or based on simulations with and without the side reflector.

When performing (206) the set of simulations to identify optimal uniform design parameters, the design automation tool varies the design parameters for each simulation run. In some cases, a single parameter is optimized at a time; in other cases, multiple parameters are changed for each simulation. Various implementations can use different granularity/step size and ranges of the variations (which is a matter of design choice and run time constraints). In some cases, the design automation tool uses built-in simulation tools. In some cases, the design automation tool communicates the varying design parameters to existing simulation tools. For example, the design automation tool may interface with or direct inputs to simulation tools by Synopsis, Lumerical, Comsol, or other companies (e.g., via application programming interfaces or other mechanisms). In some cases, the design automation tool can include or communicate with an optimization or machine learning algorithm for each apodization step to expedite the processing, which can be useful when varying three or more parameters (e.g., etch depth, fill factor, and thickness/ratio).

Accordingly, during operation 206, the method can include communicating with a simulation program to provide the varied design parameters of the initial grating coupler specification and receive initial simulation results for identifying the optimal uniform design parameters of the grating coupler. The design automation tool may send the varied design parameters individually, as a vector, or format as indicated by an application programming interface of the simulation program. When the simulation program is part of the design automation tool, during operation 206, the method can include receiving the varied design parameters of the initial grating coupler specification; performing associated simulations using the received varied design parameters; and outputting initial simulation results for identifying the optimal uniform design parameters of the grating coupler. The initial simulation results enable the design automation tool to identify optimized design parameters for grating period, fill factor, etch depth, and optionally height (including for a high contrast overlay). At this stage, the optimized parameters are uniform across the grating coupler.

When applying (208) the initial side reflector specification to the grating coupler having the identified optimal design parameters, the method 200 further includes determining an optimal spacing for the side reflector from the grating coupler having the identified optimal design parameters. The distance between the start of the teeth of the side reflector and the grating coupler can be optimized via simulations/calculations. For implementations where the grating coupler includes a high contrast overlay, the side reflector can specifically be implemented without a high contrast overlay. That is, the initial side reflector specification does not include a high contrast overlay.

When performing (210) the apodization, including associated simulations, of fill factor, etch depth, and heights for each grating tooth starting from one side until all grating teeth are apodized and an optical coupling efficiency is determined by the associated simulations, the design automation tool varies the fill factor, etch depth, and height values for each simulation run. In some cases, the fill factor, etch depth, and the height are optimized independently; in other cases, the fill factor, etch depth, and the height are synthesized/optimized together. Varying the fill factor alters the effective mode index along the grating, which improves mode matching of the grating coupler to the source. With an additional degree of freedom, the effective index of each grating period can also be increased by varying the height of the tooth (e.g., by etch depth or removing material from the top of the tooth) or the thickness of the overlay.

Various implementations can use different granularity/step size and ranges of the apodization (which is a matter of design choice and run time constraints). Similar to that described with respect to operation 206, in some cases, the design automation tool uses built-in simulation tools for the apodization; whereas in other cases, the design automation tool communicates the varying design parameters to existing simulation tools. For example, the design automation tool may interface with or direct inputs to simulation tools by Synopsis, Lumerical, Comsol, or other companies (e.g., via application programming interfaces or other mechanisms). Accordingly, during operation 210, the method can include communicating with a simulation program to provide apodized fill factor and heights and receive updated simulation results for determining the optical coupling efficiency. When the simulation program is part of the design automation tool, during operation 210, the method can include receiving apodized fill factor, etch depths, and heights; performing further associated simulations using the received apodized fill factor and heights; and outputting updated simulation results for determining the optical coupling efficiency. For implementations incorporating a side reflector, the apodization process performed during operation 210 can also include apodizing the teeth of the side reflector until the coupling efficiency is maximized and/or bandwidth is optimal.

Based on the specifications (e.g., particular design parameters and optimized fill factors, etch depths, and heights) that are identified as corresponding to the highest optical coupling efficiency, a grating coupler design can be provided (212) as output to, for example, a display of a computing device executing the design automation tool or to a subsequent layout tool. Advantageously, the described method 200 can be applied to any material system without requiring intense, complex algorithms.

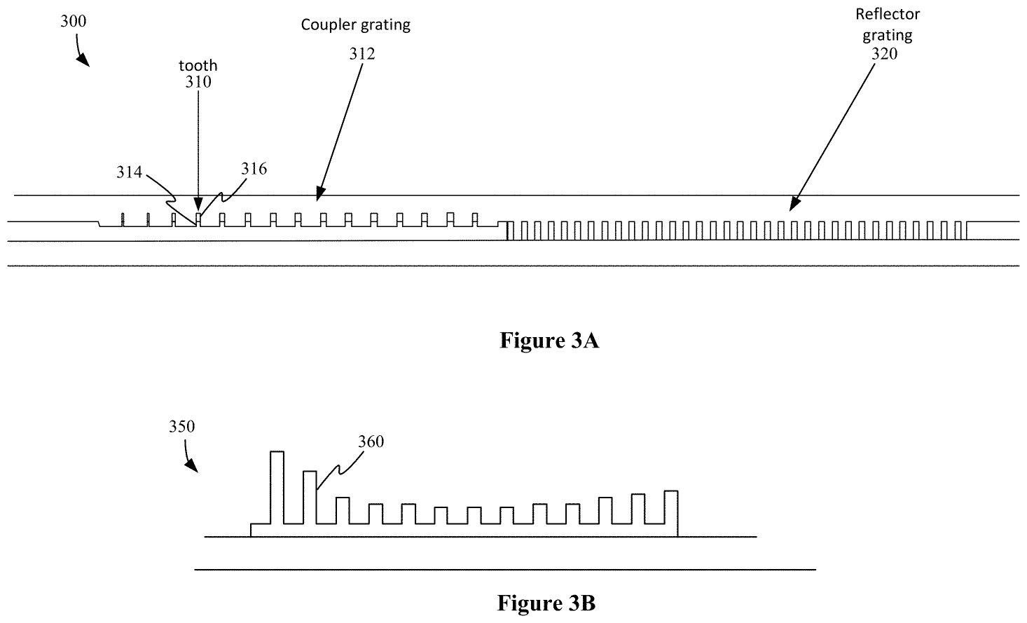

FIGS. 3A and 3B illustrate example high efficiency grating coupler designs that can be generated by a design automation tool described herein. Referring to FIG. 3A, a high efficiency grating coupler 300 with high contrast overlay can be generated with apodized fill factor and heights using method 200 as described with respect to FIG. 2. Here, the initial grating coupler specification included materials and initial parameters of a grating coupler with high contrast overlay and the design includes a side reflector. As can be seen, the teeth 310 of the coupler grating 312 are apodized, with varying fill factor but fixed heights and fixed overlay thicknesses, and include the coupler grating material 314 and the high contrast overlay material 316. Of course, in some designs, two or more of the three parameters will vary. For example, the fill factors and the heights can be varied simultaneously for each tooth sequentially. Indeed, each parameter for the elements of the coupler grating may be varied. In some cases, the thickness/height of the overlay material 316 can be varied. The high contrast overlay material 316 enables greater index contrast and heights than what is available from the coupler grating material 314 teeth alone (which can also enable a reduction of the necessary etch depth into the coupler grating material than otherwise, which is advantageous when the coupler grating material is difficult to etch or when the teeth need a high aspect ratio). The side reflector grating 320 is located an optimized distance from the coupler grating 312 and does not include the high contrast overlay material found on the coupler grating 312. Teeth of the side reflector grating 320 may also be apodized, depending on results process 210 described with respect to FIG. 2.

Referring to FIG. 3B, an all-polymer high efficiency grating coupler 350 can be generated with apodized heights but fixed fill factor using method 200 described with respect to FIG. 2. In some cases, the fill factor, etch depth, and height can be varied for each grating period sequentially. In some cases, these parameters can be varied simultaneously. Here, the initial grating coupler specification included materials and initial parameters of an all-polymer grating coupler. Although not shown a side reflector can be included. As can be seen, the teeth 360 are of varying heights (and have the same fill factors). Of course, certain implementations can use fixed heights and varying fill factors or use both varying heights and varying fill factors. Similarly, for designs incorporating a side reflector, the side reflector teeth can be of varying heights. In some designs, the height, etch depth, and the fill factor will vary.

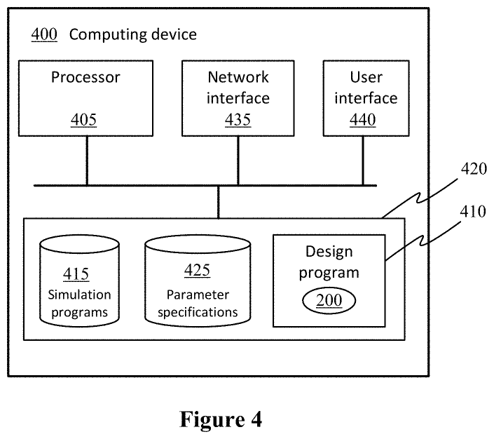

FIG. 4 is a block diagram illustrating components of a computing device used for automated grating coupler design. For example, a computing device embodied as system 400 can be used in implementing a computing device executing an optoelectronics design automation software tool incorporating the described grating coupler design functionality, including the processes described with respect to FIG. 2. It should be understood that aspects of the system described herein are applicable to both mobile and traditional desktop computers, as well as server computers and other computer systems. Accordingly, certain aspects described with respect to system 400 are applicable to server(s) on which a software tool may be carried out in the case of networked computing stations or web-based tools.

For example, system 400 includes a processor 405 (e.g., central processing unit (CPU), graphics processing unit (GPU), tensor processing unit (TPU), field programmable gate array (FPGA)) that processes data according to instructions of one or more application programs, including a design program 410 and associated simulation programs 415 stored in memory 420.

Memory 420 can be one or more of any suitable computer-readable storage medium including, but not limited to, volatile memory such as random-access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the memory 420 consist of transitory propagating signals.

As mentioned above, memory 420 can store the instructions of application programs such as programs for optoelectronics design automation including design program 410 (e.g., with instructions for method 200 described with respect to FIG. 2) and simulation programs 415. Memory 420 can also store data structures, for example for parameter specifications 425 used by the design program 410 and/or simulation programs 415.

System 400 may also include a radio/network interface 435 that performs the function of transmitting and receiving radio frequency communications. The radio/network interface 435 facilitates wireless connectivity between system 400 and the “outside world,” via a communications carrier or service provider. The radio/network interface 435 allows system 400 to communicate with other computing devices, including server computing devices and other client devices, over a network.

In various implementations, data/information, including aspects of parameter specifications 425 used by and/or stored via the system 400 may include data caches stored locally on the device or the data may be stored on any number of storage media that may be accessed by the device via the radio/network interface 435 or via a wired connection between the device and a separate computing device associated with the device, for example, a server computer in a distributed computing network, such as the Internet. As should be appreciated such data/information may be accessed through the device via the radio interface 435 or a distributed computing network. Similarly, such data/information may be readily transferred between computing devices for storage and use according to well-known data/information transfer and storage means, including electronic mail and collaborative data/information sharing systems.

System 400 can also include user interface system 440, which may include input and output devices and/or interfaces such as for audio, video, touch, mouse, and keyboard. Visual output can be provided via a display that may present graphical user interface (“GUI”) elements, text, images, video, notifications, virtual buttons, virtual keyboards, circuit or device layout, and any other information that is capable of being presented in a visual form.

One example application of the described high-efficient grating couplers generated via the described automated design tool is for optical interconnects for electronic-photonic integrated circuits.

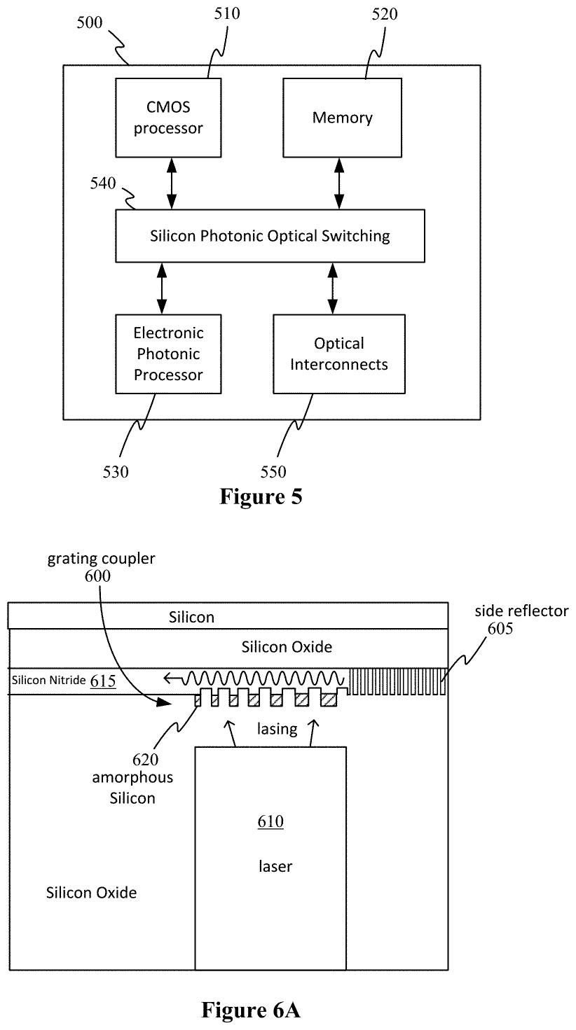

FIG. 5 illustrates an example block diagram of an electronic-photonic integrated circuit. Referring to FIG. 5, an electronic-photonic integrated circuit 500 can include a complementary metal oxide semiconductor (CMOS) processing block 510, memory 520, and an electronic-photonic processor block 530 that are interfaced with silicon photonic optical switching 540 for coupling to optical interconnects 550. Optical switching 540 can include micro-lasers, transistor laser, and light emitting transistor, as examples. Optical interconnects 550 are placed throughout the integrated system to transfer information across various platforms. The optical interconnect 550 block can include a highly efficient grating coupler that is coupled to components of the silicon photonic optical switching 540 block.

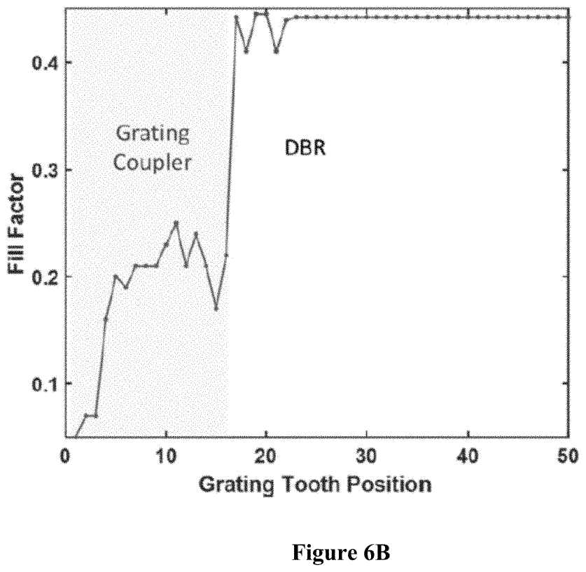

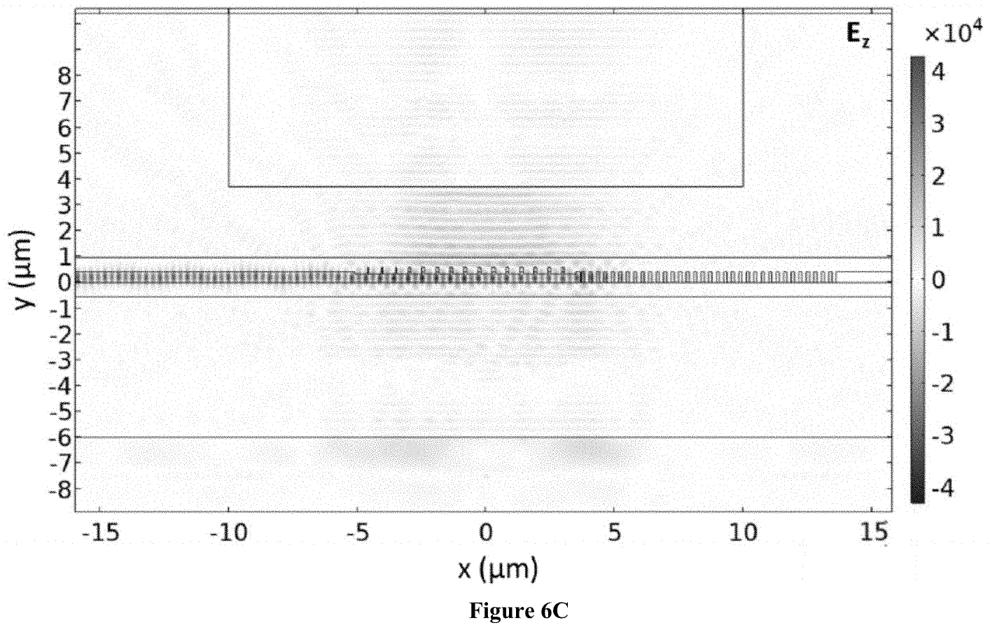

FIG. 6A shows a representative schematic of an optimized grating coupler designed for a particular vertical cavity transistor laser; FIG. 6B is a plot of fill factor of the apodized optimized grating coupler of FIG. 6A; and FIG. 6C is a simulation plot illustrating the electric field profile in the optimal design. A vertical cavity transistor laser such as illustrated in FIG. 6A is an example component of the silicon photonic optical switching 540 block of FIG. 5.

Referring to FIG. 6A, an optimized grating coupler 600 with side reflector 605 was designed for a particular vertical cavity transistor laser (VCTL) 610. For practical realization, the VCTL 610 is coupled at normal incidenceinto the grating coupler 600 to ease flip-chip integration. The illustrated design artificially increases the effective mode index of Si₃N₄ 615 by incorporating CMOS-compatible high contrast materials (e.g., amorphous Silicon 620).

The following describes the design of the optimized grating coupler of FIG. 6A.

Grating coupler 600 is a surface grating coupling, which is a type of diffraction phase grating that relies on out-of-plane illumination from an optical source into a waveguide that contains a grating structure generally formed of periodic notches of alternating refractive indices along the direction of propagation. Each tooth acts as a scatterer and the sum of their contributions in phase leads to constructive or destructive interference. At the interface, incident light is diffraction coupled into the waveguide. The efficiency of diffraction coupling relies upon the effective refractive index modulation scheme. This scheme is dependent on the grating parameters to satisfy the Bragg condition. The side reflector 605 provides directionality because without the side reflector, the vertically coupled light would exit horizontally on both sides, which is undesirable.

Advantages of this vertical coupling approach (i.e., out of plane coupling) include higher input/output port count, faster prototyping and testing, and lower losses due to the elimination of chip cleaving and polishing, which makes such a structure amenable for dense, chip-scale architectures. Therefore, surface grating couplers are suitable for coupling between different photonic and electronic layers of an interposer.

The underlying operating principle of the surface grating coupler 600 is governed by the diffraction equation which is based on the relationship between the incident angle of light, the effective index of the grating coupler, refractive index of the top cladding, diffraction order, and wavelength and grating period of an idealized grating. The grating equation can be expressed as

$${n}_{clad} * sin {θ}_{m} = {n}_{eff} - \frac{m λ}{Λ}$$

Where Λ is the period of the grating, λ is wavelength, n_{clad} is the top cladding's refractive index, and n_{eff} is the effective refractive index of the grating structure. Based on this equation, one can solve for the desired grating periodicity to first order approximation. For vertical coupling, second order (m=2) is desired to couple light perpendicularly. Typically, numerical methods such as finite element method (FEM) and finite-difference time-domain method (FDTD) are implemented to determine the optimal grating parameters for efficient coupling. Conventionally, the coupling efficiency is largely limited by the materials' refractive indices and index contrast between the grating teeth and top cladding. To circumvent this drawback, the weighted average of the tooth and groove regions can be varied to modulate the effective refractive index to improve mode matching. This variation can be achieved during process 210 described with respect to FIG. 2.

Accordingly, as described above with respect to FIG. 1D, parameters in designing a grating structure (binary design) are: the grating period, Λ, which is the interval encompassing a single tooth and notch, (2) the fill factor, fΛ, which is the duty cycle, and (3) etch depth, d, which is the vertical etched depth of the notch. For the example optimized design, a second order (m=2) grating structure was designed to operate at a center wavelength of 980 nm at normal incidence.

Silicon-on-insulator (SOI)-based devices are popular for photonic technology. However, silicon is not suitable for making waveguides for telecom wavelengths below 1000 nm due to high intrinsic absorption loss. Similarly, many III-V semiconductor materials such as InP and GaSb are absorbing at these wavelengths. Although GaAs/AlGaAs, GaP, and GaN are each transparent in the 850-1000 nm window, they are quite expensive, especially considering that a special epitaxial growth must be done to define the core and cladding layers with an unintentional doping concentration below 10¹³ cm⁻³ to achieve waveguides with adequately low propagation loss. Silicon nitride circumvents the aforementioned limitations of silicon and III-V materials by offering lower optical loss, smaller thermo-optic coefficient, and increased manufacturing flexibility. However, the lower refractive index contrast of silicon nitride on silicon dioxide (Δn≈0.5) makes it challenging to develop high-efficiency grating couplers formed of silicon nitride. High contrast overlays, for example, formed of amorphous silicon (a-Si) or titanium dioxide (TiO₂) can be used to improve the coupling efficiency for vertical to in-plane coupling. It should be understood; however, that the described automated design tool can be used to assist with optimal grating coupler designs of any of these materials.

The overlay material increases the effective mode index and the contrast with silicon oxide cladding. Amorphous silicon has high refractive index, above 900 nm wavelength, and negligible absorption. Titanium dioxide has a large refractive index and is a nearly lossless material, even below 900 nm. Silicon carbide (SiC), an alternative to TiO₂, has the largest refractive index below 900 nm, but its high temperature fabrication process limits its utility.

As described with respect to operation 206 of FIG. 2, as part of a method for designing a high efficient grating coupler, the optimal uniform design parameters are determined for a particular initial specification of the grating coupler. For example, an optimal waveguide (without grating) dimensions for single mode operation can first be determined. For the example implementation, this was performed as part of a finite element analysis software, the FEM (Finite Element Method) software package from COMSOL, Inc.

For the illustrative example, the thickness of the waveguide was set to 400 nm and the width of the waveguide was varied from 350 to 1200 nm during the simulation. The optimal dimensions of the waveguide are 900 nm by 400 nm. The optimized dimensions were determined by mode analysis to determine single mode regime with reasonable confinement factor and minimal attenuation, shown in Table 1. Transverse electric polarization was selected for its higher confinement factor and lower attenuation loss. The optimized dimensions of 400 nm in thickness and 900 nm in width give a confinement factor of 82%.

TABLE 1

| | Effective Mode | Propagation Constant | Attenuation |
|---|---|---|---|
| Polarization | Index | (rad/cm) | (rad/cm) |
| TM | 1.7239 | 1.105 × 10⁷ | 7.66 × 10⁻¹¹ |
| TE | 1.72709 | 1.135 × 10⁷ | 2.62 × 10⁻¹⁰ |

2D FEM simulations in COMSOL are first performed without including a side reflector for directionality. In this example implementation, a titanium dioxide overlay onto silicon nitride waveguide and an amorphous silicon overlay onto silicon nitride waveguide were independently simulated, results shown in Table 2.

TABLE 2

| Uniform Design | TiO₂/Si₃N₄ Grating | a-Si/Si₃N₄ Grating |
|---|---|---|
| Grating Period | 580 nm | 548 nm |
| Duty Cycle | 35% | 22% |
| Etch Depth | 200 nm | 83 nm |
| Waveguide Thickness | 400 nm | 400 nm |
| High Index Layer Thickness | 100 nm | 172 nm |
| Effective Mode Index (TE) | 1.7709 | 1.7709 |
| Number of Periods | 12 | 12 |
| Total Coupling Efficiency | 55.9% | 84.76% |
| Left | 27.95% | 42.38% |
| Right | 27.95% | 42.38% |
| Power Down | 33% | 4% |
| Power Up | 7.1% | 9% |

Once the uniform design parameters are determined, a fully etched side distributed Bragg reflector (DBR) was incorporated for in-plane directionality such as described with respect to operation 208 of FIG. 2. The high contrast material is removed from the top of the distributed Bragg grating to improve the coupling efficiency.

To achieve mode matching of the light to the fiber, apodization such as described with respect to operation 210 of FIG. 2 was performed by varying the fillfactor of one grating period at a time in sequential order from left to right. After varying the first five grating elements, the coupling efficiency to the left output waveguide increased from 79% to 85%. Afterwards, the fill factor continued to be varied along the grating coupler, and the coupling efficiency increased to 88%. Based on the back reflections and substrate loss occurring at the waveguide extension, the waveguide extension was converted to two HCG grating periods and their fill factors were also varied. As a result, the coupling efficiency reached 92.6%. Thus, it was discovered that the waveguide extension was not necessary for optimization. The DBR fillfactor was varied by changing the width of the DBR tooth. Another parametric study was performed on each DBR element by adjusting the spacing and DBR fill factor to determine the optimal geometry of each element of the in-plane DBR. The optimal number of teeth in the side reflector is determined before apodization. The elements were varied until the coupling efficiency remained constant. The maximum coupling efficiency reached 93.8%. This is the highest reported efficiency for silicon nitride in buried oxide without bottom reflector, which makes the described approach highly amenable for integrated photonic applications. Table 3 shows the design optimization to improve coupling efficiency for the example implementation. The fill factor profile for this optimal design is given in FIG. 6B. The electric field profile in z of the final optimal design is given in FIG. 6C.

TABLE 3

| | | Uniform GC | | Apodized GC | | Apodized GC |
|---|---|---|---|---|---|---|
| | Uniform | and Side | | and Side | | and Apodized |
| a-Si/Si₃N₄ | GC | DBR | | DBR | | DBR |
| Grating | 544 nm | 544 | nm | N/A | | N/A |
| Period | | | | | | |
| Duty Cycle | 22% | 22% | | N/A | | N/A |
| Etch Depth | 83 nm | 83 | nm | 83 | nm | 83 nm |
| Waveguide | 400 nm | 400 | nm | 400 | nm | 400 nm |
| Thickness | | | | | | |
| Number of | 16 | 16 | | 16 | | 16 |
| Periods for | | | | | | |
| GC | | | | | | |
| Si₃N₄ DBR | N/A | 169 | nm | 169 | nm | N/A |
| Length | | | | | | |
| SiO₂ DBR | N/A | 98 | nm | 98 | nm | N/A |
| Length | | | | | | |
| Number of | N/A | 34 | | 34 | | 34 |
| Periods for | | | | | | |
| DBR | | | | | | |
| Top BOX | 3 μm | 3 | μm | 3 | μm | 3.6 μm |
| Thickness | | | | | | |
| Total | 84.8% | 79% | | 92.6% | | 93.8% |
| Coupling | | | | | | |
| Efficiency | | | | | | |

The fabrication process for the illustrated design was carried out in twelve steps, listed in Table 4. It should be understood that this fabrication process is just one approach and that other approaches are contemplated based on locality, cost, materials, etc.

TABLE 4

| Step | Tools | Objective |
|---|---|---|
| 1 | Sandvik LPCVD/Oxidation/ | LPCVD Nitride |
| | Anneal Furnace | |
| 2 | Oxford PlasmaLab 100 PECVD | Deposit amorphous silicon |
| 3 | Elionix E-beam Writer | Lithographically define the first |
| | | pattern layer |
| 4 | Lesker 75 PVD with DC/RF | Nickel deposition |
| | Sputterer | |
| 5 | Ultrasonicate Water Bath | Metal lift-off |
| 6 | Oxford Cobra ICP Etcher | Dry etch amorphous silicon and |
| | | silicon nitride |
| 7 | Elionix E-beam | Lithographically define the |
| | | second pattern layer |
| 8 | Denton Vacuum Explorer 14 | Chromium deposition |
| 9 | Ultrasonicate Water Bath | Metal lift-off |
| 10 | Oxford Cobra ICP Etcher | Dry etch silicon nitride |
| 11 | Heated Water Bath | Chromium/nickel etch in a |
| | | covered glass dish |
| 12 | Oxford PlasmaLab 100 PECVD | Deposit silicon oxide |

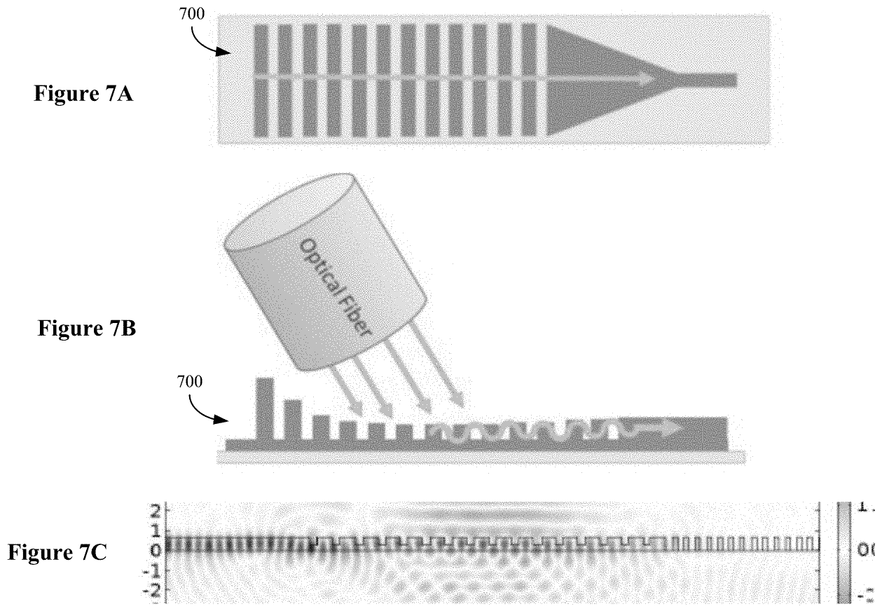

FIGS. 7A and 7B show a top view and cross section view of a representative apodized polymer grating structure; and FIG. 7C is an electric field simulation plot illustrating optimal design of the apodized polymer grating coupler of FIG. 7B.

Referring to FIGS. 7A and 7B, an optimized all-polymer grating coupler 700 was designed. Optical polymers have garnered a huge amount of interest as an ancillary material system in integrated photonic applications given their low-cost, versatility, rapid mass-producibility and flexibility. Particularly, these organic materials, utilized as passive components, are widely employed to assist on-chip adiabatic tapering, array waveguiding, and intra- and inter-connects. Their salient features noted above enable a broad range of applications: imaging, sensing, solar cells, display technologies and wearable devices. Flexible optical waveguide and coupling structures can significantly improve the spatial arrangement on integrated photonic chips such as circuit 500 of FIG. 5. Despite these characteristics, a major drawback that impedes their wide adoption in integrated photonics is their low index contrast. The low index contrast lowers the optical confinement for waveguiding and precludes further reduction in footprint thereby inhibiting high integration density. The refractive indices of polymers are typically, 1.3 to 1.7. To cope with the low index contrast, high index nanoparticles can be incorporated in the polymer matrix. However, they can degrade functionality given the uncontrolled modification. Jointly, the fabrication processes can greatly affect the device performance due to cracks and surface roughness. The device can be slightly heated above its glass temperature to allow thermal reflow to alleviate cracks and roughness to create a smooth and uniform surface.

To power an on-chip flexible optical device requires grating couplers to efficiently provide in-coupling and out-coupling of light. The coupling efficiency has a strong dependence on the various geometrical parameters of the grating structure. An all-polymer high efficiency grating coupler 700 can be configured by apodizing gratings in the vertical direction by varying the height of each tooth and groove linearly along the grating and varying the fill factor.

The following describes the design of the optimized grating coupler 700 of FIGS. 7A and 7B.

An all-polymer material system was carefully chosen that possesses a high index contrast. For the example implementation, UV-curable polymers by Norland product, NOA 164, were selected for their high refractive index as waveguide material. The choices for the bottom cladding are a spin-on dielectric: IC1-1000 or NOA 1315. Polyethylene terephthalate (PET), a plastic substrate, is chosen as the substrate.

The single mode regime is determined for the grating system with SOD and NOA 1315 as the bottom cladding. The optimal waveguide thickness is 700 nm with a buried oxide (BOX) layer thickness of 10 μm. Following identification of a single mode polymer waveguide dimensions, 2D FEM simulations of the grating coupler shown in FIGS. 7A and 7B were performed using COMSOL to optimizethe grating parameters. The initial results shown revealed little coupling into the structure when fully etched. The highest coupling efficiency of this grating coupler is around 7%, which is comparable to measure coupling efficiencies of all-polymer gratings. Therefore, another study performed varying the etch depth to boost the coupling efficiency by 35%. For directionality, an in-plane DBR was appended to the grating coupler and apodized as performed above. The design is given in Table 5. The apodized grating structure reached a coupling efficiency of nearly 62%. This is the highest reported coupling efficiency for an all-polymer system. The field profile for this simulation is shown in in FIG. 7C.

TABLE 5

| | Designs | | | | |
|---|---|---|---|---|---|
| GC Properties | Full | Partial | Side | Apodized | Apodized GC and |
| Grating Parameters | Etch | Etch | DBR | GC | Apodized DBR |
| Grating Period (nm) | 1100 | 1122 | 1122 | 1122 | 1122 |
| Etch Depth (nm) | 700 | 414 | 400 | 400 | 400 |
| Fill Factor (%) | 60 | 67 | 67 | 67 | 67 |
| Coupling Efficiency (%) | 6.56 | 41.57 | 37.12 | 58.18 | 61.67 |

The fabrication described in this section for the prototype entails depositing the bottom cladding with a low refractive index onto the PET substrate. The thickness should be at least 5 μm. Depending on the bottom cladding material, the curing may be thermal or using ultra-violet (UV) illumination. Afterwards, a submaster mold is created using gray-scale electron lithography to define the grating coupling pattern. A thin film layer of aluminum oxide is deposited onto the submaster mold using atomic layer deposition (ALD) to ensure the demolding process is efficient. The liquid waveguide material is then dispensed onto the submaster with the inverted substrate (bottom cladding/PET). The sample is UV cured with the high index material for waveguiding sandwiched between the substrate and submaster mold. The sample is demolded from the submaster mold. A conformal layer of high index material is dispensed on top of the sample and UV cured. If the desired film properties are achieved, the high index top cladding will be spun on using a spin coater, and subsequently cured using UV illumination. The resulting sample may be slightly heated to smooth the rough surface It should of course be understood that other fabrication approaches are possible and that the above-described approach is merely an example.

As described above, the methods and processes described herein can be embodied as code and/or data. The software code and data described herein can be stored, for example as modules, on one or more computer readable media, which may include any device or medium that can store code and/or data for use by a computer system. As used herein, computer readable storage media/medium should not be construed to consist of transitory propagating signals.

Accordingly, embodiments of the subject invention may be implemented as a computer process, a computing system, or as an article of manufacture, such as a computer program product or computer-readable storage medium. Certain embodiments of the invention contemplate the use of a machine in the form of a computer system within which a set of instructions, when executed, can cause the system to perform any one or more of the methodologies discussed above, including providing a software tool or a set of software tools that can be used during the physical design of integrated circuits and/or printed circuit boards and/or system level design and associated test pattern generation. The set of instructions for the software tool can be stored on a computer program product, which may be one or more computer readable storage media readable by a computer system and encoding a computer program including the set of instructions and other data associated with the software tool.

By way of example, and not limitation, computer-readable storage media may include volatile and non-volatile memory, removable and non-removable media implemented in any method or technology for storage of information such as computer-readable instructions, data structures, program modules or other data. Examples of computer-readable storage media include volatile memory such as random-access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the term “storage media” consist of transitory propagating signals.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A high efficiency grating coupler, comprising:
a grating region formed of a first material on an optics substrate;
a side reflector formed of the first material, the side reflector being on the optics substrate adjacent the grating region, wherein the side reflector comprises side reflector teeth having apodized fill factor, etch depth, and heights; and
a high contrast overlay on the grating region, wherein the high contrast overlay is not disposed on the side reflector,
wherein the grating region comprises teeth formed of the first material and the high contrast overlay, wherein the teeth have independently apodized fill factor, etch depth, and heights.

2. The high efficiency grating coupler of claim 1, wherein the optics substrate comprises a laser.

3. The high efficiency grating coupler of claim 2, wherein the first material and a material of the high contrast overlay correspond to a particular laser type, wavelength of the laser, and material of the laser.

4. The high efficiency grating coupler of claim 2, wherein the teeth of the grating region are apodized for optimized optical coupling efficiency with respect to the laser.

5. A computer-readable storage medium storing a design automation tool that when executed by a computing system, direct the computing system to perform a method comprising:
receiving parameters for a laser for which a grating coupler is being designed, wherein the parameters for the laser comprise a laser type, wavelength of the laser, material of the laser, and properties of the laser beam of the laser;
determining a corresponding initial grating coupler specification for the laser based on the received parameters, wherein the initial grating coupler specification is selected from a set of initial grating coupler specifications, wherein the set of initial grating coupler specifications comprise at least one high contrast overlay initial grating coupler specification;
performing a set of simulations while varying design parameters of the initial grating coupler specification to identify optimal uniform design parameters of the grating coupler for the laser;
performing apodization, including associated simulations, of fill factor, etch depth, and heights for each grating tooth starting from one side until all grating teeth are independently apodized and an optical coupling efficiency is determined by the associated simulations; and
providing specifications of the grating coupler having the apodized fill factor, etch depth, and heights.

6. The computer-readable storage medium of claim 5, wherein the method further comprises:
performing a constrained optimization such that the resulting dimensions are fabricable by a selected set of tools.

7. The computer-readable storage medium of claim 5, wherein the method further comprises:
applying an initial side reflector specification of a side reflector to the grating coupler having the identified optimal uniform design parameters; and
determining an optimal spacing for the side reflector from the grating coupler having the identified optimal uniform design parameters.

8. The computer-readable storage medium of claim 7, wherein the method further comprises:
performing apodization of the side reflector during the performing of the apodization of the fill factor and heights for each grating tooth.

9. The computer-readable storage medium of claim 7, wherein the initial side reflector specification does not include a high contrast overlay.

10. The computer-readable storage medium of claim 7, wherein the initial grating coupler specification is one of the at least one high contrast overlay initial grating coupler specifications.

11. The computer-readable storage medium of claim 5, wherein the set of initial grating coupler specifications comprise at least one all-polymer initial grating coupler specification.

12. The computer-readable storage medium of claim 5, further comprising simulation programs stored thereon that, when executed by the computing system, receive the varied design parameters of the initial grating coupler specification; perform associated simulations using the received varied design parameters; output initial simulation results for identifying the optimal uniform design parameters of the grating coupler; receive apodized fill factor and heights; perform further associated simulations using the received apodized fill factor and heights; and output updated simulation results for determining the optical coupling efficiency.

13. A method comprising:
receiving parameters for a laser for which a grating coupler is being designed, wherein the parameters for the laser comprise a laser type, wavelength of the laser, and material of the laser;
determining a corresponding initial grating coupler specification for the laser based on the received parameters, wherein the initial grating coupler specification is selected from a set of initial grating coupler specifications, wherein the set of initial grating coupler specifications comprise at least one high contrast overlay initial grating coupler specification;
performing a set of simulations while varying design parameters of the initial grating coupler specification to identify optimal uniform design parameters of the grating coupler for the laser;
performing apodization, including associated simulations, of fill factor, etch depth and heights for each grating tooth starting from one side until all grating teeth are independently apodized and an optical coupling efficiency is determined by the associated simulations; and
providing specifications of the grating coupler having the apodized fill factor, etch depth, and heights.

14. The method of claim 13, further comprising:
applying an initial side reflector specification of a side reflector to the grating coupler having the identified optimal uniform design parameters; and
determining an optimal spacing for the side reflector from the grating coupler having the identified optimal uniform design parameters.

15. The method of claim 14, further comprising:
performing apodization of the side reflector during the performing of the apodization of the fill factor and heights for each grating tooth.

16. The method of claim 14, wherein the initial side reflector specification does not include a high contrast overlay.

17. The method of claim 14, wherein the initial grating coupler specification is one of the at least one high contrast overlay initial grating coupler specifications.

18. The method of claim 13, wherein the set of initial grating coupler specifications comprise at least one all-polymer initial grating coupler specification.

19. The method of claim 13, further comprising:
communicating with a simulation program to provide the varied design parameters of the initial grating coupler specification and receive initial simulation results for identifying the optimal uniform design parameters of the grating coupler.

20. The method of claim 13, further comprising:
communicating with a simulation program to provide apodized fill factor and heights and receive updated simulation results for determining the optical coupling efficiency.
